(19) United States
(12) Patent Application Publication
(10) Pub. No.: US 2015/0293533 A1
(43) Pub. Date: Oct. 15, 2015

(54) Scanned Code Instruction and Confinement Sytem for Mobile Electronic Devices

(71) Applicants: Ali Ebrahimi Afrouzi, San Jose, CA (US); Soroush Mehrnia, Copenhagen (DK)

(72) Inventors: Ali Ebrahimi Afrouzi, San Jose, CA (US); Soroush Mehrnia, Copenhagen (DK)

(73) Assignee: BOBSWEEP INC., Toronto (CA)

(21) Appl. No.: 14/680,240

(22) Filed: Apr. 7, 2015

Related U.S. Application Data
(60) Provisional application No. 61/978,972, filed on Apr. 13, 2014.

(51) Int. Cl. G05D 1/02

(52) U.S. Cl. CPC G05D 1/0214; G05D 1/0225; G05D 1/0234; Y10S 901/01

(57) ABSTRACT

A method for instructing operation of a mobile automated robotic device through scannable targets printed with codes corresponding to programmatic instructions. Targets are strategically placed by users or administrators in a workspace in locations visible to the device through scanning. Devices are equipped with one or more scanners that continuously scan available surfaces for targets, executing the programmatic instructions corresponding to codes of identified targets.

### CROSS-REFERENCE TO RELATED APPLICATIONS

This application claims the benefit of provisional patent application Ser. No. 61/978,972, filed Apr. 13, 2014 by the present inventor.

### FIELD OF THE INVENTION

This invention relates to mobile automated robotic devices that are designed to perform tasks such as vacuuming, mopping, or cutting grass, within a specific area.

### BACKGROUND OF INVENTION

The following is a tabulation of some prior art that presently appears relevant:

### U.S. Patent Documents

| Pat. No. | Kind Code | Issue Date | Patentee |
|---|---|---|---|
| 4,700,427 | A | Oct. 20, 1987 | Knepper |
| 8,428,776 | B2 | Apr. 23, 2013 | Letsky |
| 8,659,256 | B2 | Feb. 25, 2014 | Irobot Corporation |
| 5,353,224 | A | Oct. 4, 1994 | Goldstar Co. Ltd. |
| 5,537,017 | A | Jul. 16, 1996 | Siemens |
| | | | Aktiengesellschaft |
| 5,548,511 | A | Aug. 20, 1996 | White Consolidated |
| | | | Industries, Inc. |
| 5,634,237 | A | Jun. 3, 1997 | Paranjpe |

### U.S. Patent Application Publications

| Publication Nr | Kind Code | Publ. Date | Applicant |
|---|---|---|---|
| 20030120379 | A1 | Jun. 26, 2003 | Storage |
| | | | Technology |
| | | | Corporation |
| 20080221729 | A1 | Sep. 11, 2008 | Erwann Lavarec |

Various systems have been proposed to confine and control automated robotic devices within subsections of workspaces. It can be advantageous to confine a robotic vacuum, for example, in a portion of a workspace so that it can adequately clean that space before moving on to another area.

A need exists for an inexpensive method to confine an automated robotic device within a subsection of a workspace that does not require additional power-consuming hardware, intensive setup or installation, or physical barriers.

A need exists for an unobtrusive method to control an automated robotic device's functions or behavior based on the device's location.

### SUMMARY

It is a goal of the present invention to provide a method to automatically provide navigation and operation instructions to an automated robotic device that is inexpensive, does not require additional power-consuming hardware or significant work from a user to install or set up, and does not rely on physical barriers.

It is a goal of the present invention to increase user customizability of an automated robotic device.

It is a goal of the present invention to provide a method to confine an automated robotic device within a subsection of a workspace that is inexpensive, does not require additional power-consuming hardware or significant work from a user to install or set up, and does not rely on physical barriers.

The current invention achieves the aforementioned goals through a system of scannable targets strategically placed in a workspace and scanners on an automated robotic device to detect the targets and transmit data thereon to a processing subsystem. The device adjusts its behavior according to instructions encoded on the targets. Targets may take the form of stickers, having a transparent and adhesive backing. Targets are placed horizontally on surfaces that the device travels over or vertically on walls or objects that the device encounters.

### BRIEF DESCRIPTION OF THE DRAWINGS

FIG. 1A shows an overhead view of the underside of a robotic floor-cleaning device equipped with the described system.

FIG. 1B shows a perspective of a robotic floor-cleaning device equipped with the described system.

FIG. 2 demonstrates a robotic device using a downward oriented scanner to scan and interpret a target placed on the floor.

FIG. 3 demonstrates a robotic device using its vertically oriented scanner to read a target placed vertically.

FIG. 4 shows an example of a target encoded with a code.

### DETAILED DESCRIPTION

While the invention will be described in terms of an autonomous robot designed for cleaning floors, it is to be understood that the control system and methods described herein can be implemented into any type of autonomous machine that must perform a desired activity within a desired area of confinement or can use certain per point instructions, including without limitation, cleaning machines, polishing machines, repair machines, and demolition machines.

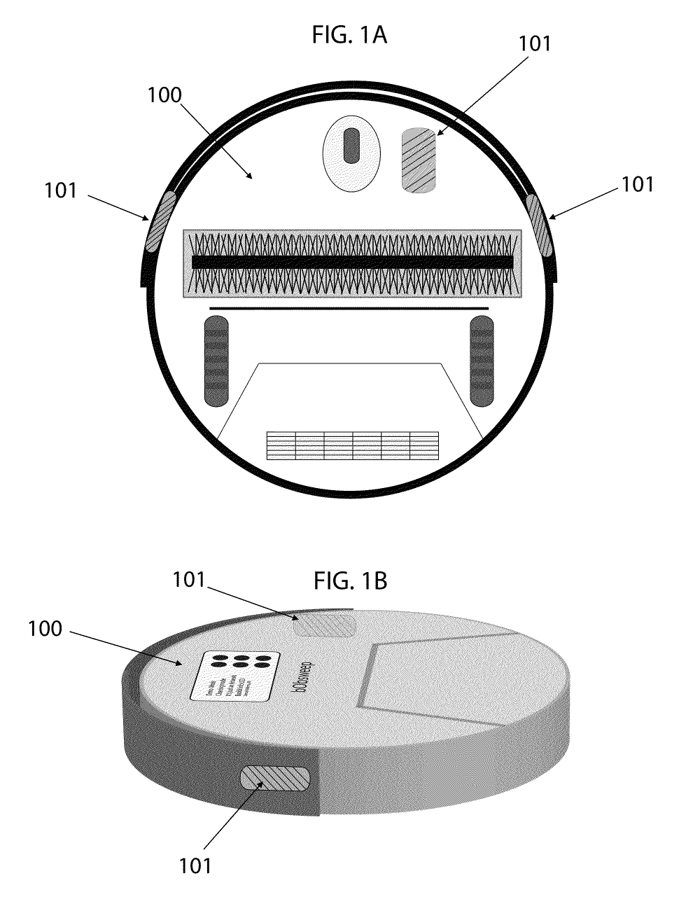

An automated robotic vacuum equipped with the proposed system is shown in FIG. 1A and FIG. 1B. FIG. 1A shows an overhead view of the underside of the vacuum 100. In this example, a set of scanners 101 are installed on the sides and underside of the vacuum to scan surfaces for recognized targets. Targets are preprinted with codes that correspond to codes saved in a memory unit of the device. The number and placement of scanners may vary. FIG. 1B shows a perspective view of the vacuum 100 and its side-mounted scanners 101. Vertically-mounted scanners can scan surfaces in vertical planes, such as walls or furniture. Horizontally-mounted scanners can scan surfaces in horizontal planes, such as the flooring beneath the vacuum. Upon detecting a target with any one of the scanners, an image of the code thereon is captured and sent to a processing subsystem of the vacuum for processing.

Upon receiving an image of a code, a processing subsystem identifies the instructions corresponding to the code and causes the vacuum to execute the instructions. Instructions may include programmatic instructions to enable, disable, or change processes carried out the vacuum, such as instructions to increase speed, stop rotation of vacuum bristles, or activate a mopping accessory, and or instructions to direct or stop movement of vacuum. The instructions associated with each code could be fixed or configurable. Instructions could be used to change the robot's function beyond the location of the target. For example, one code could be used to indicate to a combination vacuuming and mopping robotic device to stop mopping and utilize the vacuum function only beyond the point where the code is encountered.

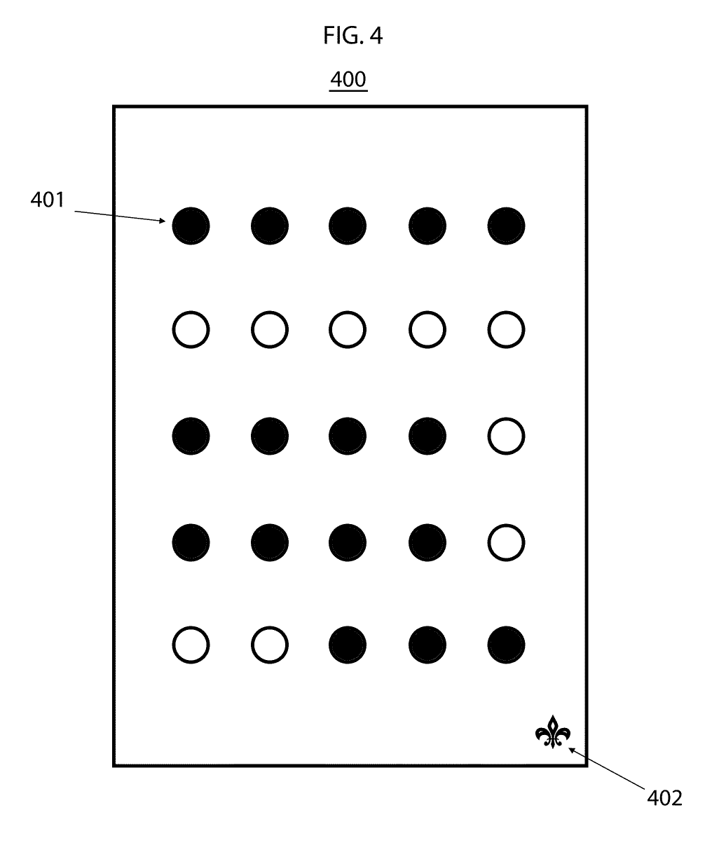

FIG. 4 depicts an example of a target 400. The target is printed with a code 401. The codes on the targets could take any format. In this example, dotted codes are shown, but bar codes, or any other type of code that can be scanned by the automated robotic vacuum could be utilized. A reference point 402 is included on each target so that it can be scanned from any direction and reoriented so that the processing subsystem may correctly read the code regardless of the robot's orientation to the target.

In some embodiments, the codes are printed with ink that is only visible when illuminated by ultraviolet light so that they are invisible to the naked eye and do not interfere with the aesthetics of the environment. In such cases, scanners are equipped with ultraviolet lights to illuminate the targets and capture the codes.

In the preferred embodiment, the target takes the form of a sticker with a transparent adhesive backing so that it does not interfere with the aesthetics of the environment.

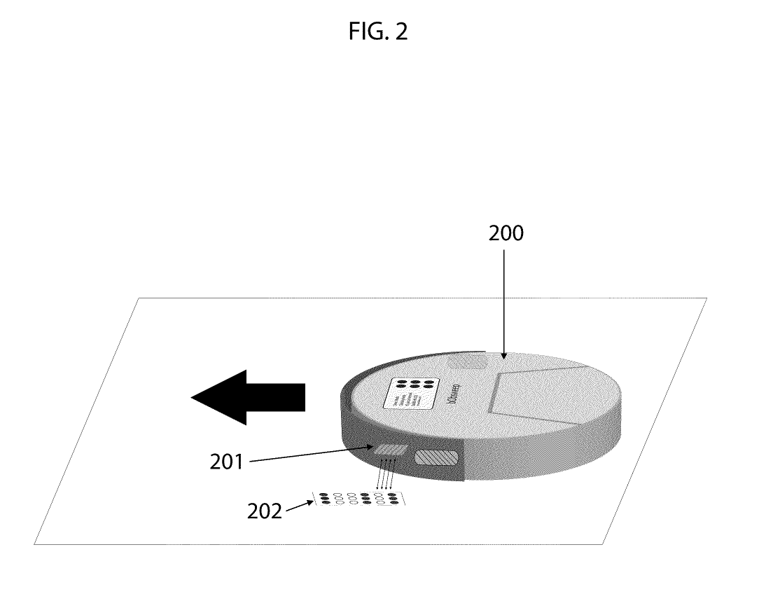

FIG. 2 depicts the robotic device 200 using its scanner 201 to scan the code on the target 202. In this example, the scanner located on the underside of the robotic device scans the plane on which the device is traveling.

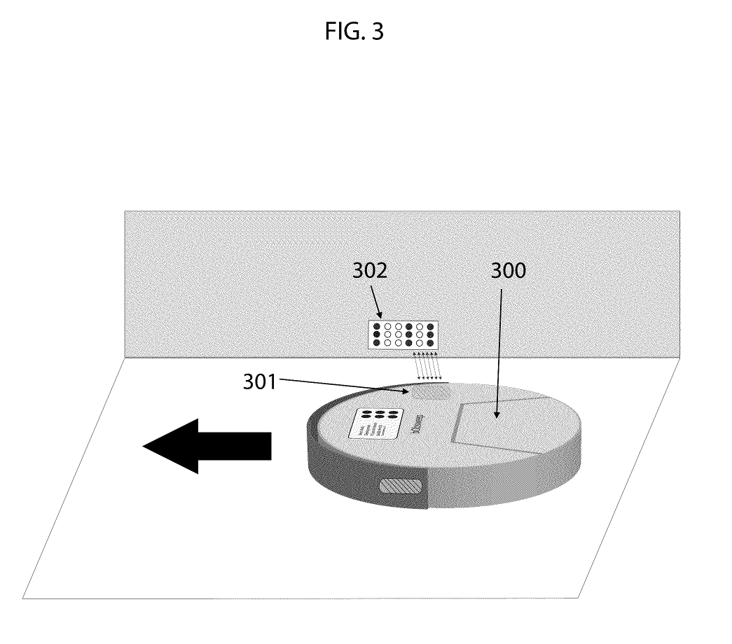

As shown in FIG. 3, a vertically oriented scanner 301 can scan vertical surfaces, such as walls or other obstacles with vertical planes. The side-mounted scanner 301 on the vacuum 300 detects and scans the code on the target 302.

In one embodiment, a target may be encoded with instructions for the robotic device to not pass the target until it has reached a preset number of encounters with that target, at which point the robot passes the target and resets the counter to zero. This could be useful to contain a vacuum in one part of a house for a period of time, and then contain the vacuum in different section of the house thereafter.

In the preferred embodiment, the system can be used in conjunction with an external control unit that emits data signals and data signal receiver on the vacuum. Signals could be infrared waves, radio waves, wifi, Bluetooth, or any other type of wireless signals. The external control unit could take the form of a remote control, a web-based application on a computer, PDA, or smartphone, or any other type of external data signal emitter. In this embodiment, the user would be enabled to configure the instructions associated with each code and thus customize the vacuum's behavior. The user could thus effectively activate or deactivate targets as, desired, permanently until the user makes another change, or temporarily for a user-defined amount of time. Additionally, the user would be enabled to turn on or off the various scanners of the vacuum through the external control unit. For example, if a user wants the vacuum to only heed instructions from floor-mounted targets, he or she could turn off the vertically-mounted scanners. This practice would also serve to conserve energy.

In one embodiment, a docking station of the robotic device could also be used as a communication gateway between the external control unit and the automated robotic vacuum. In this embodiment, the docking station would be equipped with signal receivers to receive data sent from the external control unit and signal emitters to relay the information to the device.

In some embodiments, the docking station or external control unit could also be used to indicate to the robotic device the number of targets in the system and the type of targets.

In the preferred embodiment, if the processing subsystem receives an unreadable image of a code, the robotic device is configured to drive closer to the target and retry to scan the code.

While the invention has been described with respect to specific examples including presently preferred modes of carrying out the invention, numerous variations and permutations of the described system are possible. It is to be understood that other embodiments may be utilized and structural and functional modifications may be made without departing from the scope of the present invention. Thus, the spirit and scope of the invention should be construed broadly as set forth in the appended claims.

We claim:

1) A method for delivering programmatic instructions to an automated robotic device comprising:
one or more strategically placed scannable targets; and
an automated robotic device equipped with one or more scanners; wherein programmatic instructions consist of any of:
instructions to enable, disable, or change processes carried out by said automated robotic device; or
instructions to direct or stop movement of said automated robotic device.

2) The method of claim 1 in which said targets are printed with scannable codes corresponding to programmatic instructions for said automated robotic device that are programmed in a memory unit of said automated robotic device.

3) The method of claim 2 wherein said printed codes are in the format of dot codes, bar codes, or any other type of scannable code.

4) The method of claim 1 in which said one or more of said one or more scanners are positioned on one or more vertical planes of said automated robotic device to scan targets placed on planes parallel to said one or more vertical planes.

5) The method of claim 1 in which one or more of said one or more scanners are positioned on one or more horizontal planes of said automated robotic device to scan targets placed on planes parallel to said one or more horizontal planes.

6) The method of claim 1 in which said automated robotic device continually scans available surfaces with said one or more scanners for recognized codes during operation.

7) The method of claim 2 in which, upon scanning a recognized code, said automated robotic device sends an image of said code captured by one of said one or more scanners to a processing subsystem, said processing subsystem causing said automated robotic device to execute the programmatic instructions corresponding to the code in said captured images.

8) The method of claim 2 in which said scannable targets further comprise a reference point for a processing subsystem to correctly orient said codes.

9) The method of claim 1 in which said scannable targets take the form of stickers with an adhesive backing.

10) The method of claim 9 in which said backing is transparent.

11) The method of claim 2 in which said codes are printed with ink only visible when illuminated by ultraviolet light and said scanners utilize ultraviolet lights to detect said codes.

12) The method of claim 2 in which the specific programmatic instructions that are associated with certain codes can be configured by a user on an external control unit and provided to said automated robotic device through signals sent from said external control unit to a data signal receiver of said automated robotic device.

13) The method of claim 12 in which said external control unit is a remote control, a web-based application accessible through a PDA, computer, smartphone, or other web-enabled device, or any other device or application that can remotely send signals to a data signal receiver.

14) The method of claim 12 in which a docking station of said automated robotic device is used as a communication gateway between said external control unit and said automated robotic device, said docking station being operable to receive data signals from said external control unit and send data signals to said automated robotic device.

15) The method of claim 12 in which said data signals consist of infrared signals, radio frequencies, wifi signals, Bluetooth signals, or any other kind of available wireless signal.

16) The method of claim 13 in which said data signals consist of infrared signals, radio frequencies, wifi signals, Bluetooth signals, or any other kind of available wireless signal.

17) The method of claim 1 in which programmatic instructions may further include instructions for said automated robotic device to not travel beyond a particular target until a counter of said automated robotic device identifies that said automated robotic device has incurred a preset number of encounters with that target, at which point said automated robotic device passes the target and resets said counter to zero.

18) The method of claim 1 in which said one or more scanners may be turned on or off individually or together by a user.

19) The method of claim 2 in which multiple sets of instructions are encoded on individual targets, each set being assigned a priority level.

20) The method of claim 7 in which, if said processing subsystem receives an unreadable scanned image, said automated robotic device is configured to drive closer to the target in question and attempt to scan the target again.
